(19) United States
(12) Patent Application Publication
(10) Pub. No.: US 2018/0372533 A1
(43) Pub. Date: Dec. 27, 2018

(54) Ultrasonic Sensor For Determining A Liquid Level

(71) Applicant: CONTINENTAL AUTOMOTIVE GMBH, Hannover (DE)

(72) Inventor: Karl-Friedrich PFEIFFER, Erlangen (DE)

(73) Assignee: Continental Automotive GmbH, Hannover (DE)

(21) Appl. No.: 16/060,809

(22) PCT Filed: Nov. 17, 2016
(86) PCT No.: PCT/EP2016/077948

§ 371 Date: Jun. 8, 2018

(30) Foreign Application Priority Data
Dec. 11, 2015 (DE) 10 2015 224 932.8

(51) Int. Cl. G01F 23/296; F16L 37/098; F01M 11/12

(52) U.S. Cl. CPC G01F 23/2968; F01M 11/12; F16L 37/098; G01F 23/2962

(57) ABSTRACT

An ultrasonic sensor for determining a liquid level having an elongated housing which has an outer tube and an inner tube arranged therein and serves as a measurement chamber, and a base on which the housing is arranged and in the region of which an ultrasonic transceiver is located. To assemble these three parts, the ultrasonic sensor is provided with an outer-tube lower edge that is extended radially outward and serves to fix the housing to the base. The lower edge is latched with a hook-shaped latching element arranged on the base. The latching connection affords the possibility of arranging the housing in different positions in the circumferential direction.

### CROSS REFERENCE TO RELATED APPLICATIONS

This is a U.S. national stage of application No. PCT/EP2016/077948, filed on Nov. 17, 2016. Priority is claimed on German Application No.: DE102015224932.8, filed Dec. 11, 2015, the content of which is incorporated here by reference.

### BACKGROUND OF THE INVENTION

### 1. Field of the Invention

The present invention relates to an ultrasonic sensor for determining a liquid level, having an elongated housing that has an outer tube and an inner tube arranged therein, which serves as a measurement chamber, and a base on which the housing is arranged and in the region of which an ultrasonic transceiver is located.

### 2. Description of the Prior Art

Ultrasonic sensors of this type are known. A known sensor is configured such that it has three parts, namely an inner tube, an outer tube and a corresponding cap. These parts are assembled in three steps. The inner tube is inserted into the outer tube, the outer tube is welded to a corresponding base housing by a laser, and in the final step, the cap is placed on the outer tube and latched together therewith. In this method, in which a laser welding operation is used, it is necessary for the outer tube to be configured in a laser-transparent manner. As a result, the material costs generally rise.

WO 2008/009277 A1 discloses an ultrasonic sensor of the type described above. The sensor functions such that the inner tube, configured as a measurement chamber, holds the liquid of which the level is intended to be measured. Outside the measurement chamber, the liquid assumes the same level as inside the measurement chamber. The acoustic signals emitted by the ultrasonic transceiver are reflected by the surface of the liquid and received by the transceiver to ascertain the liquid level from the sound propagation time.

Located between the outer tube and the inner tube is a further liquid chamber, which serves to prevent the penetration of air bubbles into the actual measurement chamber, since the liquid is introduced into the measurement chamber via the further chamber. An ultrasonic sensor of this type serves in particular to ascertain the engine oil level in motor vehicles.

No details about the assembly of the above-described ultrasonic sensor are provided in the cited publication.

### SUMMARY OF THE INVENTION

The present invention is based on providing an ultrasonic sensor of the type described at the beginning, which is particularly easy to assemble and is usable in a variable manner.

In the case of an ultrasonic sensor of the specified type, this object is achieved according to one aspect of the invention in that it is provided with an outer-tube lower edge that is extended radially outward and serves to fix the housing to the base, said lower edge being able to be latched together with at least one hook-shaped latching element arranged on the base.

The invention provides an easy and cost-effective possibility of assembling the ultrasonic sensor, for which no complicated measures need to be taken. To this end, all that is necessary is for the lower edge of the outer tube to be formed appropriately, namely have a lower edge that is extended radially outward.

Provided on the base element is at least one hook-shaped latching element, with which the outer tube is latchable via the thickened lower edge. When the outer tube is fixed to the base, the outer tube, with the inner tube fixed thereto, is placed on the base such that the thickened edge pushes the hook-shaped latching element radially outward. Once the edge has passed over the latching portion of the latching element, the latching element springs back and comes to rest over the edge such that the outer tube is locked to the base. As a result of force being applied in a radial direction, the outer tube can be removed from the latching element again.

The at least one hook-shaped latching element is preferably configured such that it has a main portion that extends upward from the base and a flexible hook portion that extends radially inward and obliquely downward from the tip thereof. When the outer tube is placed on the base, the thickened edge therefore pushes the flexible hook portion radially outward, which then, after passing over the edge, springs back inward again and comes to rest on the edge and locks the latter.

Preferably, the sensor has a multiplicity of latching elements arranged in a circle, between which a liquid inlet opening into the outer tube is arranged. For example, six latching elements are arranged, which pass into a latching connection with the thickened lower edge of the outer tube.

This type of fixing of the outer tube to the base has the advantage that the outer tube can assume any desired positions in the circumferential direction when only its liquid inlet opening is arranged between two latching elements. The outer tube can therefore be turned until it assumes the desired position, without the internal structure of the ultrasonic sensor being negatively affected as a result. Therefore, the position of the ultrasonic sensor can be adapted for example easily to the situation within an oil pan, for example with regard to the oil return lines or for the oil dripping from the cylinder cooling. As a result of the different possible positions of the outer tube in the circumferential direction, in particular the effect of avoiding the inlet of air bubbles into the measurement chamber is not impaired.

Therefore, for the configuration according to the invention, only the outer tube and the base need to be configured appropriately, wherein in particular the outer tube forms a very simple molded part. The two parts can be mounted on one another and separated from one another again easily. In order to fasten the outer tube to the base, a laser-transparent material is not required.

In the ultrasonic sensor configured according to aspect of the invention, the outer tube and the inner tube expediently each have a liquid inlet opening and a deaeration opening. The liquid entering the sensor first passes through the chamber formed between the outer tube and inner tube and then passes into the inner tube, i.e. the actual measurement chamber, wherein the desired deaeration takes place outside the measurement chamber, with the result that foam formation is avoided.

In a development of the invention, the outer tube has on its inner side and/or the inner tube has on its outer side at least one radial partition wall which serves to position the inner tube in the outer tube. Via these partition walls, it is also possible for the liquid to be guided in a labyrinthine manner before it enters the measurement chamber, in order to further favor deaeration.

In a specific embodiment, a radially extending lug is arranged on the at least one partition wall, said lug engaging in a cutout on the inner side of the outer tube or the outer side of the inner tube. As mentioned above, the inner tube is fixed to the outer tube, after which the outer tube is mounted on the base. This fixing can be realized for example via a lug of this type. Such a clamping connection between the outer tube and inner tube is preferred in order to allow easy mounting and removal for repair or maintenance purposes.

In a particularly preferred embodiment of the invention, three partition walls are provided between the outer tube and inner tube, said partition walls subdividing the annular space between the inner tube and outer tube into three regions or spaces. These partition walls can be provided with corresponding through-openings for the liquid, specifically in a manner distributed over the height of the sensor, resulting in extended flow paths for the liquid to be measured, which favor defoaming.

In these three partition walls, provision is especially made for the first partition wall to extend from the base to the cover, the second partition wall to have a liquid through-opening at a distance from the base, and the third partition wall to have a liquid through-opening at its lower end and a deaeration opening at its upper end. In this case, the liquid enters through the outer tube, wherein the first closed partition wall specifies a single direction of flow in the circumferential direction. The liquid then passes to the second partition wall and passes through the opening provided therein, wherein the wall portion of the second partition wall under the liquid through-opening is preferably inclined, in order to encourage the air bubbles that are entrained in the liquid to move upward and in order to reduce the quantity of foam which passes into the second space between the second and third partition walls. The liquid can then pass through this partition wall into the third space and from there into the measurement chamber.

As a result, a labyrinthine flow path is formed, which serves to prevent air bubbles from penetrating into the inner tube, in which the level measurement is carried out.

Furthermore, the outer tube preferably has a cover that extends over the inner tube and is configured in a manner typically fixed to the outer tube or integral therewith, such that a special cap-mounting operation does not have to take place.

As already mentioned, the outer tube can be fixed to the base in different positions in the circumferential direction. In this case, appropriate measures can be provided, which specify a particular position of the outer tube in the circumferential direction, i.e. have the effect that automatically only one position can be realized. In a specific embodiment, to fix the housing in the circumferential direction, one of the latching elements has a cutout with which a lug arranged on the outer side of the outer tube can come into engagement. Of course, a reverse embodiment can also be realized, in which a lug on any latching element engages in a cutout in the outer tube.

If, with this combination of lug and cutout, the corresponding dimensions are configured in a larger manner than the gaps between the individual latching elements, a latching operation can be realized only in one position, which is defined by the corresponding lug/cutout combination.

### BRIEF DESCRIPTION OF THE DRAWINGS

The invention is explained in detail in the following text by way of an exemplary embodiment in conjunction with the drawing, in which:

FIG. 1 is a schematic longitudinal section through an ultrasonic sensor;

FIG. 2 is a schematic horizontal section through the ultrasonic sensor in FIG. 1;

FIG. 3 is a developed view of the inner tube of the ultrasonic sensor in a schematic illustration; and

FIG. 4 is an illustration of the fixing of the outer tube to the base in a schematic view from above.

### DETAILED DESCRIPTION OF THE PRESENTLY PREFERRED EMBODIMENTS

The ultrasonic sensor illustrated in the figures has an inner tube 3, in the interior of which a measurement chamber 17 is formed, an outer tube 2 with a cap 6 formed integrally therewith, and a base 1, on the underside of which an ultrasonic transceiver 21 (illustrated only schematically) is arranged. The ultrasonic sensor illustrated here is located, for example, in the oil pan of a motor vehicle, wherein the oil level in the measurement chamber 17 and in the intermediate space between the outer tube 2 and inner tube 3 is indicated at 4. This oil level 4 is intended to be ascertained by an ultrasonic propagation time measurement by the transceiver 21.

The oil, the level of which is intended to be measured, in this case passes through an inlet opening 12 (not shown in FIG. 1) through the outer tube into the intermediate space between the outer tube 2 and inner tube 3 and is guided in a labyrinthine manner therein as far as the inlet opening 7 into the measurement chamber 17 in the inner tube 3. Furthermore, a deaeration opening 8 for the measurement chamber 17 is illustrated in FIG. 1.

The labyrinthine path of the oil into the measurement chamber 17 is intended to prevent air bubbles from being introduced therewith into the measurement chamber 17 and therefore a foam layer forming in the measurement chamber. Deaeration is therefore already intended to take place before entry into the measurement chamber 17.

The ultrasonic sensor illustrated here includes three parts, the base 1, the outer tube 2 with cap 6, and the inner tube 3. During assembly, the inner tube 3 is fixed to the outer tube, for example by a lug on a partition wall proceeding from the radial inner tube, which partition wall engages in a cutout in the outer tube. The unit consisting of the outer tube 2 and inner tube 3 is then fixed to the base 1 in that the unit is latched together with the base 1.

The outer tube 2 has an edge 9 that is extended radially outward. Furthermore, six latching elements 10 that are arranged in a circle at a spacing from one another are arranged on the base, the latching elements 10 having a hook-shaped design and having an upwardly extending main portion and a flexible hook portion 11 extending obliquely downward from the tip. When the outer tube 3 is placed on the base 1, the thickened lower edge 9 of the outer tube 2 pushes the flexible hook portions 11 of the individual latching elements 10 radially outward and slides downward along them. When the edge has passed over the flexible portion 11, the hook portion 11 moves radially inward again and assumes an end position over the thickened edge 9. In this way, the outer tube 2 is latched together with the base 1.

The corresponding latched position is illustrated from above in FIG. 4. In order that the outer tube can assume only one particular position in the circumferential direction when it is placed on the base, the lower edge 9 of the outer tube 2 is provided with a radially outwardly protruding lug 16 that engages in a corresponding cutout in a latching element 10. Since the lug 16 is configured in a larger manner than the distance between two adjacent latching elements 10, the outer tube can be fixed only in this single position.

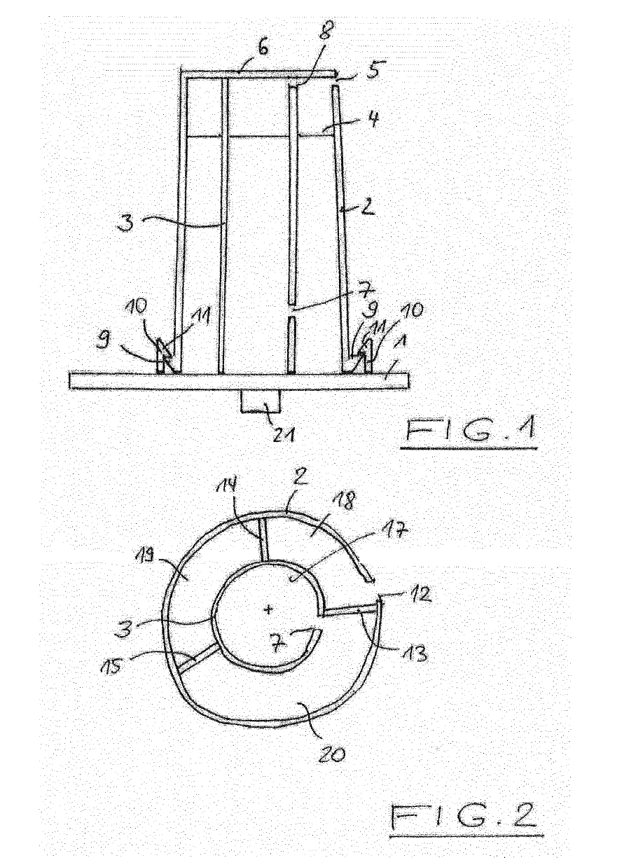

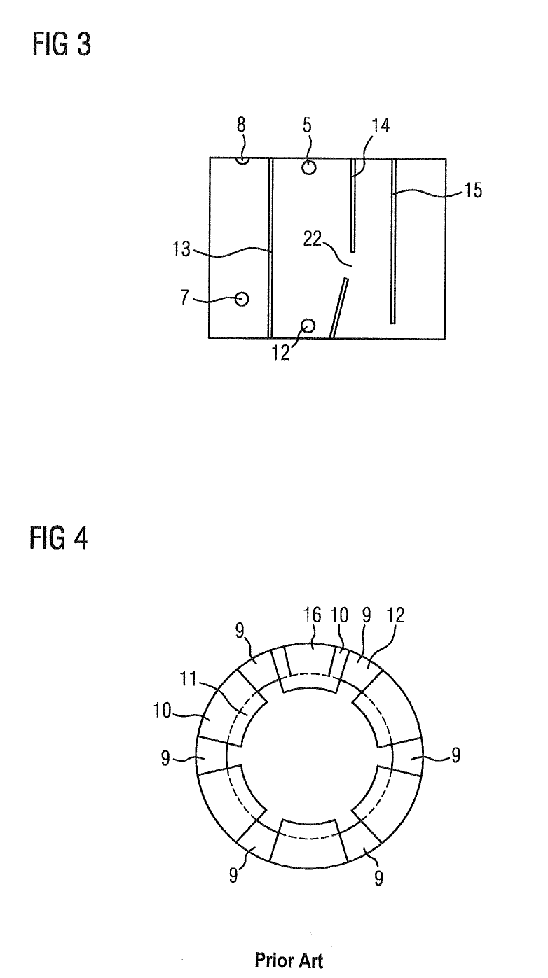

The internal structure of the ultrasonic sensor is illustrated in FIGS. 2 and 3. In the embodiment illustrated here, the inner tube 3 has three radially outwardly directed partition walls 13, 14, 15, via which the inner tube 3 is arranged centrically in the outer tube 2. In order to fix the inner tube 3 to the outer tube 2, it is possible here for one or more partition walls to have corresponding lugs, which engage in cutouts in the outer tube.

By way of the partition walls 13, 14, 15, three spaces 18, 19, 20 are formed between the outer tube 2 and inner tube 3, through which the oil passing in through the outer tube at 12 has to travel in order to pass through the inlet opening 7 into the measurement chamber 17. As a result, a labyrinthine path for the oil is formed, in order to ensure deaeration outside the measurement chamber.

FIG. 3 shows a developed view of the inner tube 3. It can be seen that the partition wall 13 passes through from bottom to top. The partition wall 14 has a through-opening 22 at a distance from the lower end, wherein the lower wall portion of the partition wall 14 is configured in an inclined manner in order to encourage deaeration. The third partition wall 15 has a through-opening at its lower end and a deaeration opening at its upper end.

The deaeration opening of the outer tube is indicated at 5, and the inlet opening into the outer tube is indicated at 12. The numeral 7 denotes the inlet opening into the inner tube and the numeral 8 denotes the deaeration opening of the inner tube.

The oil passes into the first space 18 via the inlet opening 12 and, as a result of the continuous partition wall 13, is guided to the through-opening 22 in the second partition wall 14. It passes into the space 19 and flows through the lower opening in the partition wall 15 into the space 20, from which it passes via the inlet opening 7 into the measurement chamber 17. The oil passing into the measurement chamber 17 is then accordingly deaerated. The appropriate level measurement can now take place in the measurement chamber 17.

For maintenance or repair of the ultrasonic sensor, the outer tube 2 with the inner tube 3 can be taken off the base 1 by applying force upward, wherein the corresponding flexible hook portions 11 are pushed outward and then snap back flexibly into their starting position.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. An ultrasonic sensor for determining a liquid level, comprising:
an ultrasonic transceiver;
a housing comprising:
an outer-tube having an end edge that is extended radially outward; and
an inner tube that is arranged in the outer-tube and configured as a measurement chamber; and
a base on which the housing is arranged and in a region of which the ultrasonic transceiver is located, the base having at least one hook-shaped latching element configured to fix the outer-tube end edge to the base by being latched together.

13. The ultrasonic sensor as claimed in claim 12, wherein the at least one hook-shaped latching element has a main portion that extends vertically from the base and a flexible hook portion that extends radially inward and obliquely downward from a tip thereof.

14. The ultrasonic sensor as claimed in claim 12, further comprising a plurality of latching elements arranged in a circle, between two of the a plurality of latching elements a liquid inlet opening into the outer-tube is arranged.

15. The ultrasonic sensor as claimed in claim 12, wherein the outer-tube and the inner tube each have respective liquid inlet openings and respective deaeration openings.

16. The ultrasonic sensor as claimed in claim 12, wherein at least one of:
the outer-tube has on its inner side at least one radial partition wall configured to position the inner tube in the outer-tube and
the inner tube has on its outer side the at least one radial partition wall configured to position the inner tube in the outer-tube.

17. The ultrasonic sensor as claimed in claim 16, wherein a radially extending lug is arranged on the at least one radial partition wall, the lug engaging in a cutout on the inner side of the outer-tube or the outer side of the inner tube.

18. The ultrasonic sensor as claimed in claim 16, wherein three partition walls are provided between the outer-tube and inner tube, the three partition walls subdividing an annular space between the inner tube and outer-tube into three spaces.

19. The ultrasonic sensor as claimed in claim 18, wherein a first partition wall extends from the base to a cover, a second partition wall has a liquid through-opening at a distance from the base, and a third partition wall has a liquid through-opening at its end proximate to the base and a deaeration opening at its end opposite the base.

20. The ultrasonic sensor as claimed in claim 19, wherein a wall portion of the second partition wall under the liquid through-opening is inclined.

21. The ultrasonic sensor as claimed in claim 12, wherein the outer-tube has a cover that extends over the inner tube.

22. The ultrasonic sensor as claimed in claim 12, wherein, in order to fix the housing in a circumferential direction, one of the latching elements has a cutout with which a lug arranged on the outer side of the outer-tube is configured to be brought into engagement.

23. The ultrasonic sensor as claimed in claim 17, wherein three partition walls are provided between the outer-tube and inner tube, the three partition walls subdividing an annular space between the inner tube and outer-tube into three spaces.
